(19) United States
(12) Patent Application Publication
(10) Pub. No.: US 2003/0020444 A1
(43) Pub. Date: Jan. 30, 2003

(54) Low drop voltage regulator

(75) Inventor: Petr Kamenicky, Brno (CZ)

Correspondence Address: SUGHRUE MION, PLLC, 2100 Pennsylvania Avenue, N.W., Washington, DC, 20037-3213, US

(73) Assignee: ALCATEL

(21) Appl. No.: 10/195,555

(22) Filed: Jul. 16, 2002

(30) Foreign Application Priority Data
Jul. 26, 2001 (EP) 01402036.6

(51) Int. Cl. G05F 3/16

(52) U.S. Cl. 323/315

(57) ABSTRACT

The present invention is related to a voltage regulator circuit for providing a regulated output voltage (Vₒᵤₜ) at an output terminal, said regulator circuit comprising

a first current source (I₂),

a comparator circuit and

a current mirror circuit, comprising a driver transistor (T₄) and a follower transistor (T₅), interposed between said first current source and said output terminal,

operatively linked as to regulate an input voltage Vᵢₙ to said regulated output voltage by comparing said output voltage with a reference voltage (V_{ref}) and adjusting said first current source to maintain said regulated output voltage at said output terminal, characterized in that

the circuit further comprises a regulator device interposed between said first current source and said driver transistor.

### FIELD OF THE INVENTION

The present invention is related to supply regulators, more particularly to voltage regulator circuits of the low drop type.

### STATE OF THE ART

Supply regulators are commonly used throughout electric and electronic equipment to provide a stable voltage or current supply from an input that may vary in time and over different load conditions. Low drop regulators are known to perform well and are in high demand due to their high stability and low energy losses. Current low-drop regulators (see FIG. 1) have a standard basic output circuit consisting of a p-type current mirror (T₄, T₅) wherein the driving circuit (T₄) is in saturation. The voltage drop across T₅ can only be reduced by having a small on-resistance Rₒₙ, thus by a combination of a high V_{GS}, and by a large W/L ratio.

Obtaining a very high V_{GS} is difficult due to the quadratic I/V relationship of the current through T₄ (the gain in V_{GS} is very small compared to the current increase that is needed). So a very large PMOS for T₅ and/or a very big current through T₄ is needed to obtain a satisfying result.

Another solution known in the art is described in U.S. Pat. No. 6,188,211. The solution proposed in this document however is relatively complicated since it contains a lot of transistors and since it makes use of bipolar transistors. The latter therefore requires the availability of an expensive BICMOS process.

### AIMS OF THE INVENTION

The present invention aims to provide a new low drop regulator which is low-cost, can be realised using CMOS processing, which is stable, modest in power consumption and which performs well.

### SUMMARY OF THE INVENTION

The present invention concerns a voltage regulator circuit for providing a regulated output voltage (Vₒᵤₜ) at an output terminal, said regulator circuit comprising

a first current source,

a comparator circuit and

a current mirror circuit, comprising a driver transistor and a follower transistor, interposed between said first current source and said output terminal,

operatively linked as to regulate an input voltage Vᵢₙ to said regulated output voltage by comparing said output voltage with a reference voltage and adjusting said first current source to maintain said regulated output voltage at said output terminal, characterised in that the circuit further comprises a regulator device interposed between said first current source and said driver transistor.

Said regulator device is preferably selected from the group consisting of a regulator resistor and regulator transistor.

In case said regulator device is a regulator transistor, said regulator transistor has a fixed gate voltage, and said first current source is directly coupled to the gate of said follower transistor. Advantageously, the voltage regulator circuit further comprises a biasing transistor and a second current source arranged to provide the fixed gate voltage of the regulator transistor. The fixed gate voltage is preferably selected such that for a certain maximal current Iₘₐₓ through the driver transistor, the driver transistor is in linear mode of operation.

A voltage regulator circuit according to the invention can further comprise an input terminal for applying a reference voltage. Preferably, the comparator circuit is an error amplifier arranged to generate an output voltage at an output node based upon a voltage difference between said regulated output voltage and said reference voltage.

A voltage regulator circuit according to the present invention has preferably said driver transistor and said follower transistor interconnected at their gate, both transistors being connected with their source to said input terminal, the output terminal being the drain of the follower transistor. Said first current source is preferably interposed between said output node of said error amplifier and the drain of said driver transistor. Advantageously, the current mirror circuit is of the p-type.

### SHORT DESCRIPTION OF THE DRAWINGS

FIG. 1 represents the standard basic low-drop regulator circuit from the prior art.

FIG. 2 represents a preferred embodiment of the new regulator circuit according to the present invention.

FIG. 3 represents another embodiment of the new regulator circuit according to the present invention.

### DETAILED DESCRIPTION OF THE INVENTION

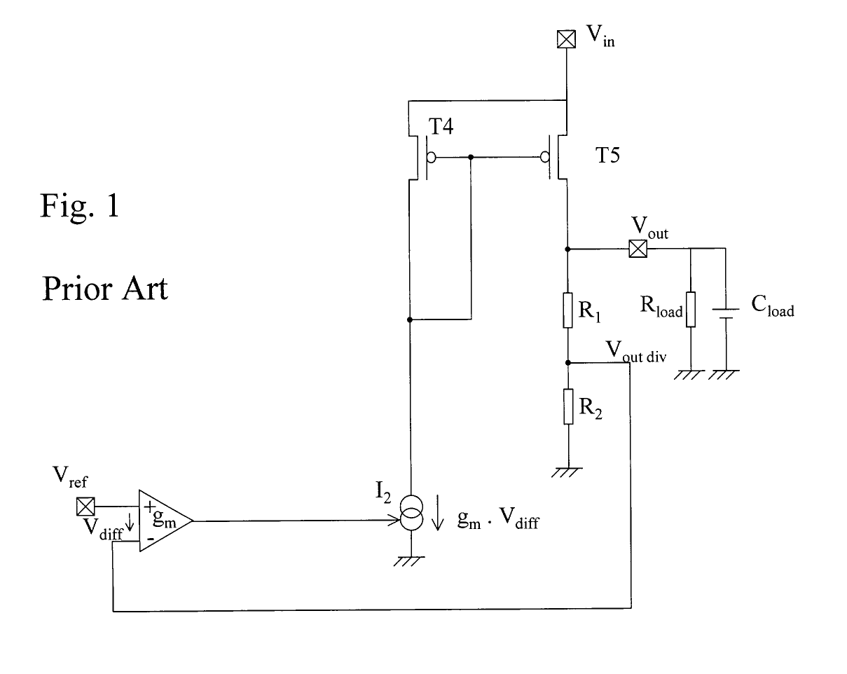

The present invention provides a low-cost pure CMOS alternative to the solutions known in the art. One of the prior art low-drop regulators is, by means of reference, shown in FIG. 1. Such a low-drop regulator provides a regulated output voltage Vₒᵤₜ at a same named output terminal, from an input voltage Vin, which is an input signal to this voltage regulator circuit at a same named input terminal, by comparing said output voltage with a reference voltage V_{ref}, provided to the voltage regulator at a same named input terminal, and by adjusting a first current source, denoted I2, to maintain the regulated output voltage at the output terminal. In FIG. 1 and the other figures the operation of the first current source is schematically depicted by means of the expression gₘ.Vdiff, which serves as an example for this regulation, and which indicates that the current source I2 is operative based on the result of the comparator, which is denoted as circuit gm. Vdiff is thereby the input voltage to this comparator. A person skilled in the art is adapted to realise such comparators and current sources in voltage regulators and a detailed circuit for this current source and comparator is thereby not shown. The voltage regulator circuit further comprises a current mirror circuit, comprising a driver transistor (T₄) and a follower transistor (T₅), interposed between said first current source and said output terminal.

The main feature of the present invention consists in the addition to this prior art circuit, of a regulator device for creating a more suitable current/voltage characteristic for driving the follower transistor T₅. This current/voltage characteristic is preferably an s-type voltage/current characteristic. Said regulator device can e.g. be a resistor or, more preferably, a transistor circuit.

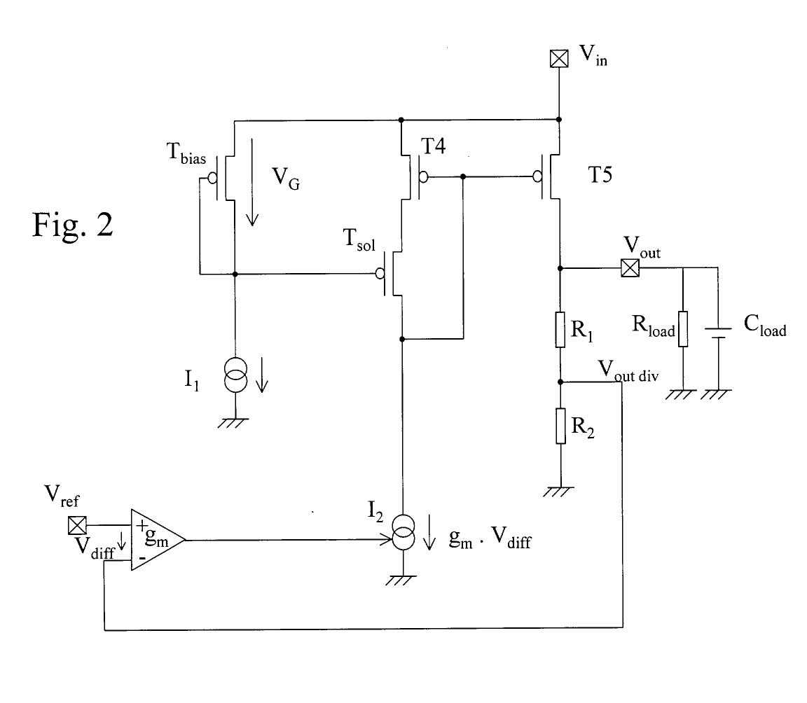

As can be seen in FIG. 2, an additional transistor (Tₛₒₗ) is added in series with T₄, whereby this additional transistor is driven by a fixed gate voltage denoted V_{G}. This gate voltage V_{G} is such that for a certain maximum current Iₘₐₓ through T₄, T₄ will be driven in its linear mode of operation such that the current source I₂ will force the voltage on the gate of T₅ low. V_{GS} of T₅ will thus increase substantially more compared to the saturation region. This thus allows T₅ to conduct much larger currents compared to the prior art case, such that T₅ can accordingly be made much smaller for having the same output current as in the prior art. The fixed V_{G} can be obtained by a transistor T_{bias} biased from a fixed current source I₁.

For this configuration, following equation applies:

$${I}_{max} ≅ \frac{{I}_{1} \times \frac{{L}_{( {T}_{bias} )}}{{W}_{( {T}_{bias} )}}}{{( \sqrt{\frac{{L}_{( {T}_{solution} )}}{{W}_{( {T}_{solution} )}} + \sqrt{\frac{{L}_{( T4 )}}{{W}_{( T4 )}}}} )}^{2}}$$

whereby

Iₘₐₓ denotes the maximum current through T₄, being a design parameter for the voltage regulator.

L_{(Tbias)} denotes the length of transistor Tbias

W_{(Tbias)} denotes the width of transistor Tbias

L_{(Tsol)} denotes the length of transistor Tsol

W_{(Tsol)} denotes the width of transistor Tsol

L_{(T4)} denotes the length of transistor T4

W_{(T4)} denotes the width of transistor T4

Iₘₐₓ is thus process and temperature independent.

The stability of the loop for currents through the first current source, I₂ larger than Iₘₐₓ, is achieved mainly by following factors:

a) big V_{GS} of T₅ pushes T₅ into linear mode and thus decreases the open loop gain

b) the comparator being a differential transconductance stage (gₘ), can be easily designed with transconductance decrease for bigger input voltage V_{diff}, if an unbalanced differential pair configuration is chosen, and thus with decrease of the open loop gain for I₂>Iₘₐₓ.

c) for I₂=Iₘₐₓ, even the basic loop of FIG. 1, has a good phase margin.

The present invention provides a very simple solution to the low drop regulator problem: only 2 extra transistors and a current source are needed.

A low drop regulator according to the present invention also shows smaller current consumption, as the drain current for T₄ is limited to Iₘₐₓ.

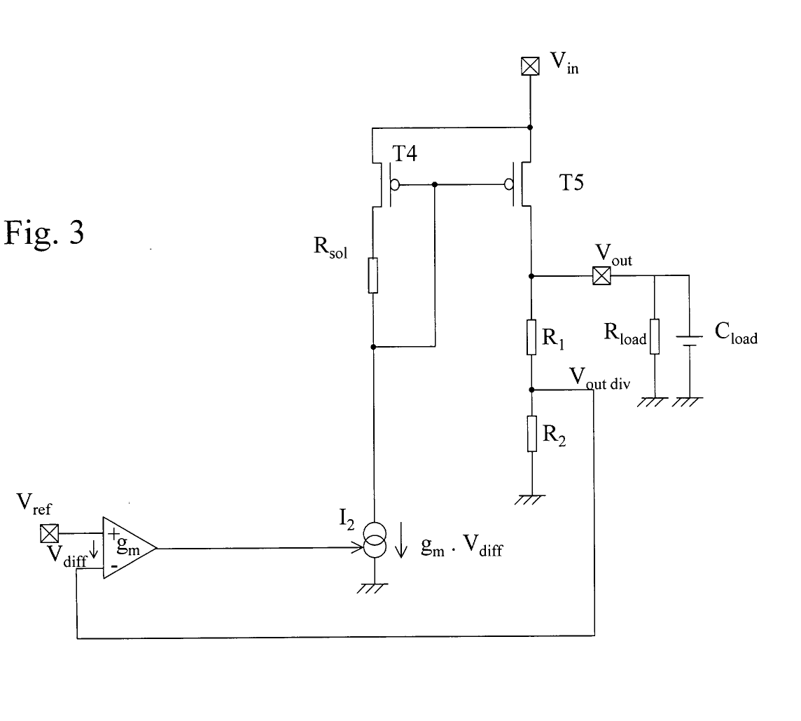

One can also envisage using a resistor as the regulator device. This can be seen in FIG. 3. An additional resistor (Rₛₒₗ) is added between the driver transistor T₄ and the current source.

Both embodiments (resistor and transistor) will result in an s-shape characteristic of T5. However, the resistor embodiment will provide an s-shape that is not as steep as in case the transistor embodiment is used, and Iₘₐₓ is not process independent anymore.

1. A voltage regulator circuit for providing a regulated output voltage (Vₒᵤₜ) at an output terminal, said voltage regulator circuit comprising
a first current source (I₂),
a comparator circuit and
a current mirror circuit, comprising a driver transistor (T₄) and a follower transistor (T₅), interposed between said first current source and said output terminal,
operatively linked as to regulate an input voltage Vᵢₙ to said regulated output voltage by comparing said output voltage with a reference voltage (V_{ref}) and adjusting said first current source to maintain said regulated output voltage at said output terminal, characterised in that
the circuit further comprises a regulator device (Tₛₒₗ;Rₛₒₗ)interposed between said first current source (I2) and said driver transistor (T4).

2. A voltage regulator circuit such as in claim 1, wherein said comparator circuit is an error amplifier arranged to generate an output voltage at an output node based upon a voltage difference between said regulated output voltage and said reference voltage.

3. A voltage regulator circuit such as in claim 1 or 2, wherein said driver transistor (T₄) and said follower transistor (T₅) are interconnected at their gate, both transistors being connected with their source to said input terminal, the output terminal being the drain of the follower transistor.

4. A voltage regulator circuit such as in any of the claims 1 to 3, wherein said first current source is interposed between said output node of said error amplifier and the drain of said driver transistor (T4).

5. A voltage regulator circuit of any of the claims 1 to 4, characterised in that the current mirror circuit is of the p-type.

6. A voltage regulator circuit such as in any of the claims 1 to 5, wherein said regulator device is a regulator resistor (Rₛₒₗ).

7. A voltage regulator circuit such as in any of the claims 1 to 5, wherein said regulator device is a regulator transistor (Tₛₒₗ) having a fixed gate voltage (V_{G}), and whereby said first current source is coupled with the gate of said follower transistor.

8. The voltage regulator circuit of claim 7, characterised in that it further comprises a biasing transistor (T_{bias}) and a second current source (I₁) arranged to provide the fixed gate voltage of the regulator transistor (Tₛₒₗ).

9. The voltage regulator circuit of claim 7 or 8, characterised in that the fixed gate voltage is selected such that for a certain maximal current Iₘₐₓ through the driver transistor (T4), the driver transistor (T4) is in linear mode of operation.
